(19) United States
(12) Patent Application Publication
(10) Pub. No.: US 2025/0047763 A1
(43) Pub. Date: Feb. 6, 2025

(54) SYSTEM AND METHOD FOR IDENTIFICATION OF DEVICE UNDER TEST

(71) Applicant: BLANCCO TECHNOLOGY GROUP IP OY, Joensuu (FI)

(72) Inventor: Jarno Manninen, Joensuu (FI)

(21) Appl. No.: 18/791,213

(22) Filed: Jul. 31, 2024

Related U.S. Application Data
(60) Provisional application No. 63/530,821, filed on Aug. 4, 2023.

(51) Int. Cl. H04L 69/16; H04L 69/22

(52) U.S. Cl. CPC H04L 69/16; H04L 69/22

(57) ABSTRACT

There is provided a system and method for use in identifying a particular mobile electronic device that is undergoing test, maintenance, or re-provisioning procedures such as diagnostic procedures, erasure, or data transfer. More particularly, the present invention provides for systems and methods for identifying a particular mobile device of a plurality of mobile devices that are proximate to one another and connected to a system platform by detecting that the particular device's sensors indicate that the device is being physically manipulated, moved, handled, or operated. Embodiments of the present invention provide techniques for an operator to confirm correct selection of a particular mobile device with visual feedback from the processing station, and may, in some embodiments, provide for initiation of testing of the specific device being manipulated or touched by the operator.

### CROSS REFERENCE TO RELATED APPLICATIONS

This application claims the full benefit of and priority to U.S. provisional patent application No. 63/530,821 filed Aug. 4, 2023 titled, “SYSTEM AND METHOD FOR IDENTIFICATION OF DEVICE UNDER TEST,” the disclosure of which is fully incorporated herein by reference for all purposes.

### FIELD AND BACKGROUND OF THE INVENTION

### Field of the Invention

The present disclosure relates to a system and method for use in identifying a particular mobile electronic device that is undergoing test, maintenance, or re-provisioning procedures such as diagnostic procedures, erasure, or data transfer. More particularly, the present invention provides for systems and methods for identifying a particular mobile device of a plurality of mobile devices that are proximate to one another and connected to a system platform by detecting that the particular device's sensors indicate that the device is being physically manipulated, moved, handled, or operated.

### Background of the Invention

Today, the use of mobile devices is widespread, and increasing numbers of people utilize such devices in their daily lives. As used herein, the term “mobile device,” generally refers to any electronic device capable of being moved from place to place. Examples of such mobile devices include, but are not limited to cellular phones (also known more generally as “mobile phones”), smart watches, smart jewelry, portable digital assistants (PDAs), digital cameras, intelligent devices for the “Internet of Things” (or “IOT”), drone devices, mobile subscriber communication devices, tablet computers, media players, smart vehicles, smart TVs, laptop computers, electronic devices equipped with accelerometers, and devices equipped with wireless intelligent agents installed such as Alexa, Google Voice, Siri, Cortana, and others. Consumers purchase millions of mobile devices such as cellular phones every year, driven by the desire for enhanced features and functionality; replacement of worn, damaged, partially nonfunctional, or slower operating devices; or simply, just to obtain the latest product based on consumer loyalty or to show off new models to friends and acquaintances. On the other hand, as more features and capabilities have been incorporated into newly-released mobile devices, the rapidly growing expense of such devices has created a secondary market for pre-owned but functional mobile devices. As such, an industry has evolved to process and recycle previously-owned mobile devices to bring them into operational condition for refurbishment and resale, or for parting out inoperable devices for valuable components or scrap.

Pre-owned mobile device processors (also known herein as “recyclers”), are faced with the challenge of taking in mobile devices such as used mobile phones that are of unknown functionality and operational state, assessing the functional condition of such devices, securely erasing all data from prior users from the mobile phones, and if necessary, effectuating any necessary repairs. With narrow profit margins arising from the competitive market conditions and pricing for recycled mobile devices, efficiency in the assessment, diagnostic, and erasure process is paramount. The recycler must quickly assess the type of device, its operational state, and conduct any necessary re-provisioning such as flashing and erasure of the mobile device in the most efficient manner possible to ensure that recycled devices are returned to the stream of commerce as quickly as possible.

In traditional mobile device recycling processes, for purposes of throughput and efficiency, recyclers at a single mobile processing station may concurrently process many mobile devices such as mobile phones, often several tens of such mobile devices at a time. In certain configurations, it may be possible to process even a hundred or more mobile devices at a single workstation. Thus, as many of such mobile devices are be connected (by wired or wireless connection) to the same processing station, and are often in close proximity to one another (such as at a workstation table or workbench), it may be difficult to specifically identify and verify association with a particular mobile device for specific processing by the mobile processing station (such as requesting an operator to pick up the specific device of interest and interactively operate a user interface component of the mobile device such as a button or a screen touch, thus allowing the connected processing station to determine whether the specific mobile device of interest is operating correctly and is correctly identified and associated with the item under test in the processing station). Moreover, to ensure test and or erasure/re-provisioning results are correct for a specific device, during processing it is essential that the operator identify the correct mobile device that is undergoing testing from the plurality of nearby devices, and for the user to confirm the association with the processing station. However, for a number of reasons, including inability to access system memory, defective user interface components, or security blocks from mobile device operating systems, installing an app on the devices under test to allow specific mobile device identification among the plurality of connected mobile devices may be problematic or in some cases, impossible.

In sum, among other things, there is a need to provide systems and methods to easily identify a specific mobile device among a plurality of mobile devices that are interconnected to a mobile device processing station and to confirm the association of the correct device with the processing station.

### SUMMARY OF THE INVENTION

The following summary of the invention is exemplary and explanatory only and is not necessarily restrictive of the invention as claimed. It should be noted that in various embodiments, description is made with reference to figures. However, certain embodiments may be practiced without one or more of these specific details, or in combination with other known methods and configurations. In the following summary and detailed description, numerous details are set forth, such as specific configurations and processes, etc., in order to provide a thorough understanding of the present invention. In other instances, well-known processes and conventional hardware have not been described in particular detail in order to not unnecessarily obscure the present invention. Reference throughout this specification to “one embodiment,” “an embodiment,” “an implementation,” “an aspect,” or the like means that a particular feature, structure, configuration, or characteristic described in connection with the embodiment is included in at least one embodiment of the invention. Thus, the appearances of the phrase “in one embodiment,” “an embodiment,” “an implementation,” “an aspect,” or the like in various places throughout this specification are not necessarily referring to the same embodiment of the invention. Furthermore, the particular features, structures, configurations, or characteristics may be combined in any suitable manner in one or more embodiments. The following Summary merely presents some concepts of the invention in a general form as a prelude to the more detailed description provided below.

Correct identification of a specific mobile device among a plurality of connected to a mobile device processing station is an essential part of any mobile device recycling process. An operator can often be prompted by the processing station to, for example, move a particular device to test its accelerometers, operate buttons such as the volume buttons, touch the screen, listen for a speaker sound, or other functions. If the correct mobile device is not being manipulated by the operator, the mobile processing station may incorrectly assume that the device it believes is being manipulated is malfunctioning. Additionally, without being prompted by a processing station, an operator may wish to select a particular mobile device that is in proximity to a number of others, and understand by looking at a display attached to the processing station, which specific device has been selected and its status and identifying information, among other things. Embodiments of the present invention provide techniques for the operator to confirm correct selection of a particular mobile device with visual feedback from the processing station, and may, in some embodiments, provide for initiation of testing of the specific device being manipulated or touched by the operator.

While in one implementation, a push notification may be generated and transmitted by the mobile processing station to a specific connected mobile device, it may be difficult or impractical to do so, as the connected mobile devices may have limited or no support for displaying notifications from the processing station. One embodiment of the present invention implements a reverse approach to the problem. Instead of pushing indications to the device, various embodiments use device monitoring of the connected mobile devices to detect operation of the devices, such as by detecting a movement of the mobile device's accelerometers, and then generate an indicia on the processing station's display such as an animated slight wobble of the specific screen icon corresponding to the device. Such exemplary visual cues provide immediate feedback to the operator, allowing the operator to match and associate the device to the graphical representation of the device connected to the processing station. The operator can also rotate device held in hand and receive an immediate feedback on the UI of the processing station, allowing notification and/or display on the processing station for the particular device. Further, this approach provides additional useful functionality to ensure the connection of the mobile device to the processing station is functioning, and the processor and sensors of the mobile device are at least partially operable. Thus, through the display by the processing station, the operator may confirm that the specific device being tested/re-provisioned by the processing station is correctly associated with a specific connected device among the plurality of connected devices.

It is known to install a diagnostic application on a mobile electronic device which, when executed by a processor of the mobile electronic device, may be used to verify whether the mobile electronic device is operating in an expected or desired manner. Such diagnostic applications may receive information indirectly from the OS of the mobile electronic device via the application programming interfaces (APIs) of the OS, which information relates to at least one of the status, the activation and/or the operation of one or more hardware inputs of the mobile electronic device. For example, such diagnostic applications may receive information indirectly from the OS of the mobile electronic device via APIs of the OS, which information relates to at least one of the status, the activation and/or the operation of one or more controls, one or more push buttons, a touchscreen, one or more sensors and the like of the mobile electronic device.

While installation of an application may in some cases provide techniques for identifying a specific mobile device among a group of connected mobile devices at the processing station, there are potential problems with this approach. For example, it may not be technically possible to install and/or execute a diagnostic application on a mobile electronic device e.g., as a consequence of lack of memory available on the mobile electronic device. Additionally or alternatively, the installation and/or execution of a third-party diagnostic application on a mobile electronic device may be prohibited by a manufacturer of the mobile electronic device and/or a manufacturer of the OS of the mobile electronic device. Also, in some circumstances, the mobile electronic device may have one or more broken controls, one or more broken push buttons, a broken touchscreen, and/or one or more broken sensors which may prevent a user of the mobile electronic device from navigating to, or executing, a diagnostic application and/or which may prevent a user of the mobile electronic device from inputting and/or receiving instructions from the mobile electronic device. Exemplary methods of the present invention provide for techniques for obtaining information from connected mobile electronic devices without the need to first install apps on the devices under test/re-provisioning.

In one embodiment, there is provided a method for identifying a particular electronic device among a plurality of mobile electronic devices connected to a processing station, the method comprising: establishing a protocol stack and respective connections between the plurality of mobile electronic devices and the processing station; repeatedly reading information from each of the plurality of connected mobile devices, the information comprising device properties respectively associated with each of the respected connected mobile devices; storing the read information in a memory of the processing station; analyzing the read information to determine that a manipulated electronic mobile device of the plurality of connected mobile devices had a change in one of its device properties; and generating a visual indicia showing confirmation of actuation of the corresponding manipulated mobile electronic device through a visual representation on a display of the processing station. Additionally, a visual indicia may further comprise visually animating on the display an iconic representation corresponding to the manipulated electronic mobile device for a predetermined period of time, and/or may also comprise one or more of changing a brightness characteristic of the iconic representation; changing a color characteristic of the iconic representation; and displaying text adjacent to the iconic representation corresponding to identification of a device type corresponding manipulated mobile electronic device. Additionally, in various embodiments, manipulating one of the connected electronic mobile devices includes an operator performing one or more of: changing orientation of the manipulated mobile electronic device through lifting and/or turning the manipulated mobile electronic device; pressing a volume button on the manipulated mobile device; tapping an area of a display of the manipulated mobile electronic device; pressing a home/touch ID button of the manipulated mobile electronic device; pressing an off/on button of the manipulated mobile electronic device; covering or approaching a proximity sensor location of the manipulated mobile electronic device; and removal and/or replacement of the manipulated mobile electronic device from a wireless charging pad. Additional aspects include prompting the operator to confirm selection of the device for initiation of a diagnostic or re-provisioning procedure; or automatically initiating a diagnostic or re-provisioning procedure for the manipulated electronic mobile device upon determining that the manipulated electronic mobile device had a change in one of its device properties; or causing the processing station to pause further operation of a predetermined process flow until upon determining that the manipulated electronic mobile device had a change in one of its device properties. An operator may be prompted in any desired manner, such as prompting the operator, by the processing station, to operate specific features of the manipulated mobile electronic device as part of a diagnostic procedure, the operation of specific features including one or more of: pressing a volume button on the manipulated mobile electronic device; tapping an area of a display of the manipulated mobile electronic device; tapping any portion of the manipulated mobile device to impart an acceleration thereto; pressing a home/touch ID button on the manipulated mobile electronic device; changing orientation of the manipulated mobile electronic device; pressing an off/on button of the manipulated mobile electronic device; covering or approaching a proximity sensor location of the manipulated mobile electronic device; and removal and/or replacement of the manipulated mobile electronic device with a wireless charging source.

Mobile devices may be connected in any desired manner, and the one or more of the plurality of mobile devices may be connected to the processing station through a wired connection, and in various embodiments, the wired connection comprises one or more of a USB connection, a Lightning port connection, or a serial port connection. Further, one or more of the plurality of electronic mobile devices is connected to the processing station through a wireless connection, which, in various implementations, may include one or more of: a Wi-Fi connection, a Bluetooth connection, a near-field communications connection, an infrared connection, or a cellular telephony connection.

The processing station of the present invention may communicatively couple to a display, wherein the display of the processing station further comprises a graphical user interface depicting a plurality of graphical representations respectively corresponding to each of the connected plurality of mobile devices. In an additional aspect, all graphical representations corresponding to each of the non-manipulated electronic devices are shown in a darker grayed-out depiction compared to the graphical representation corresponding to the manipulated electronic device. Further, upon the corresponding manipulated electronic device being identified by the processing station, alternate methods include providing a confirmation indicia to be displayed and/or annunciated on the manipulated electronic device.

Additional actions may be included in methods of the present invention as desired. For example, methods include initiating, by the processing station, a test or provisioning process on the manipulated mobile electronic device that had a change in one if its device properties.

In one embodiment, repeatedly reading information from each of the plurality of connected mobile devices may further comprise repeatedly reading information from a debug log stored in a respective data structure (such as a ring buffer) of a respective memory of each of the connected mobile devices and storing the read information in a memory of the processing station respectively associated with an identifier respectively regarding each connected mobile device; repeatedly using the information read from the debug log to construct and maintain event histories for each respective connected mobile device in the memory of the processing station; and repeatedly determining the status of each of the connected mobile electronic devices based on the stored event history. Additionally, methods of the present invention may include reading information from the stored debug log at a plurality of different instants in time, wherein any two successive instants in time are separated by a time period which is sufficiently small so as to avoid an operating system of the mobile electronic device from over-writing any information in the debug log stored in the respective memory before the information can be read. Additional aspects may also include repeatedly reading information from the debug log at regular intervals. In various embodiments, methods include reading only information from the debug log stored in the data structure at one instant in time which is new or additional to the information read from the debug log at a preceding instant in time, and additional aspects include repeatedly identifying one or more entries in, or portions of, the event history which are associated with at least one of the status, the activation and/or the operation of a hardware element of the mobile electronic device; and repeatedly determining the status of the hardware element based on the identified one or more entries in, or portions of, the event history. In one implementation, repeatedly identifying the one or more entries in, or portions of, the event history which are associated with at least one of the status, the activation and/or the operation of the hardware element comprises repeatedly searching the event history for at least one of one or more characters, one or more symbols, one or more keywords, and one or more commands associated with at least one of the status, the activation and/or the operation of the hardware element. Further aspects include repeatedly parsing the identified one or more entries in, or portions of, the event history; and repeatedly determining the status of the hardware element based on the one or more parsed entries in, or portions of, the event history.

Hardware components of the mobile devices may also include at least one of: a transducer, a component, a device, an input element, an output element, a control, a push button, a knob, a switch, a key, a keyboard, a keypad, a sensor, an accelerometer, an image sensor, a microphone, a proximity sensor, a motion sensor, a user interface, a touchscreen, an indicator, a display, and a speaker. Methods of the present invention may also comprise setting, controlling or enabling the mobile electronic device so that an operating system of the mobile electronic device writes information relating to the operation of the mobile electronic device to the debug log stored in the data structure of the mobile electronic device. In various aspects, methods of the present invention may also comprise setting, controlling or enabling the mobile electronic device so as to increase a level of detail of the information relating to the operation of the mobile electronic device which the operating system of the mobile electronic device writes to the debug log stored in the data structure of the mobile electronic device; and/or setting, controlling or enabling the mobile electronic device so as to cause the operating system of the mobile electronic device to perform verbose logging.

In various embodiments, one or more of the plurality of mobile electronic devices comprises an iOS device or an iOS operating system and the method comprises using the syslog relay service when the mobile electronic device is in normal mode; or, in additional aspects, one or more of the plurality of mobile electronic devices comprises an Android device or an Android operating system and the method comprises enabling USB debugging.

In yet another embodiment, an external processing resource of the processing station which is external to the plurality of connected mobile devices may be used to repeatedly read information from the debug log stored in the data structure of each of the connected mobile devices. In a further aspect, the external processing resource may cause the display of the processing station to repeatedly display information representative of the determined status of each of the connected mobile devices. An additional implementation comprises using the external processing resource to cause the display to display information for guiding or prompting a user of the manipulated mobile electronic device to perform one or more actions in relation to the manipulated mobile electronic devices, for example wherein the one or more actions to be performed in relation to the manipulated mobile electronic device comprise activating or operating an input element of the manipulated mobile electronic device.

The mobile electronic device of the present invention (also referred to as “mobile device”) may include any of a mobile phone, a smartphone, a smart watch, a component of smart jewelry, a portable digital assistant (PDA), a digital camera, an intelligent device for the “Internet of Things” (or “IOT”), a drone device, a mobile subscriber communication device, a tablet computer, a media player, a smart vehicle, a smart TVs, a laptop computer, and an electronic device equipped with an accelerometer, and devices equipped with wireless intelligent agents installed such as Alexa, Google Voice, Siri, Cortana, and others.

In various methods of the present invention, a color marker may be associated with each of the plurality of connected devices, and each respective graphical representations respectively corresponding to the plurality of connected devices appears in a color associated with the respective color marker. In various embodiments, shaking the manipulated mobile device results in a corresponding visual representation on the display of the processing station changing color for the visual representation. And in certain embodiments, the diagnostic and/or provisioning procedure is performed in part on the processing station and in part on the manipulated mobile device.

There is also provided a system for use in determining a status of a mobile electronic device, the system comprising the processing station including an external processing resource which is external to the plurality of connected mobile device, wherein the external processing resource is configured for communication with each of the connected mobile devices and is configured to perform the method of any preceding claim.

An additional embodiment includes a computer program stored in the memory of the processing station for use in determining a status of a mobile electronic device, the computer program being configured so that, when executed by an external processing resource external to the plurality of connected mobile device, the external processing resource performs any of the methods set forth herein.

### BRIEF DESCRIPTION OF THE DRAWINGS

A more complete understanding of the present invention may be derived by referring to the detailed description and claims when considered in connection with the following illustrative figures.

FIG. 1 illustrates an embodiment of a system of the present invention.

FIG. 2 depicts a schematic diagram of an embodiment of the system of the present invention.

FIG. 3 shows a flow diagram of a method of the present invention.

FIG. 3A shows an exemplary table of events data obtained from a connected mobile device, showing when a power button of the mobile device had been pressed and released.

FIG. 3B shows an exemplary table of events data obtained from a connected mobile device, showing when a power button and a volume down button of the mobile device had been pressed and released.

FIG. 3C shows an exemplary table of events data obtained from a connected mobile device, showing when the mobile device's orientation has been changed to various positions.

FIG. 4 illustrates an embodiment of a mobile device with labeled user interfaces.

FIG. 5 shows a linear arrangement of visual icons on a screen according to an embodiment of the present invention.

FIG. 6 illustrates a list-based arrangement of information regarding mobile devices connected to a processing station of the present invention.

FIG. 6A shows a subset illustration of an embodiment of the list-based arrangement of information as shown in FIG. 6.

FIG. 6B illustrates a sheet-based arrangement of information regarding mobile devices connected to a processing station of the present invention.

FIG. 7 illustrates a grid-based arrangement of visual icons on a screen according to an embodiment of the present invention.

FIG. 7A shows an alternative embodiment of the grid-based arrangement of visual icons on a screen of FIG. 7.

FIG. 8A illustrates a linear displacement animation of visual icons on a screen according to an embodiment of the present invention.

FIGS. 8B-8D illustrates a wobbling animation, a rotation animation about a vertical axis, and a change of visual characteristic such as brightness, hue, or color of visual icons on a screen according to an embodiment of the present invention.

FIG. 9 illustrates another system embodiment of the present invention, showing identification of a mobile device on a workstation by hovering a mouse over its corresponding icon on a display.

### DETAILED DESCRIPTION

There is presented a system and method for identifying devices under test.

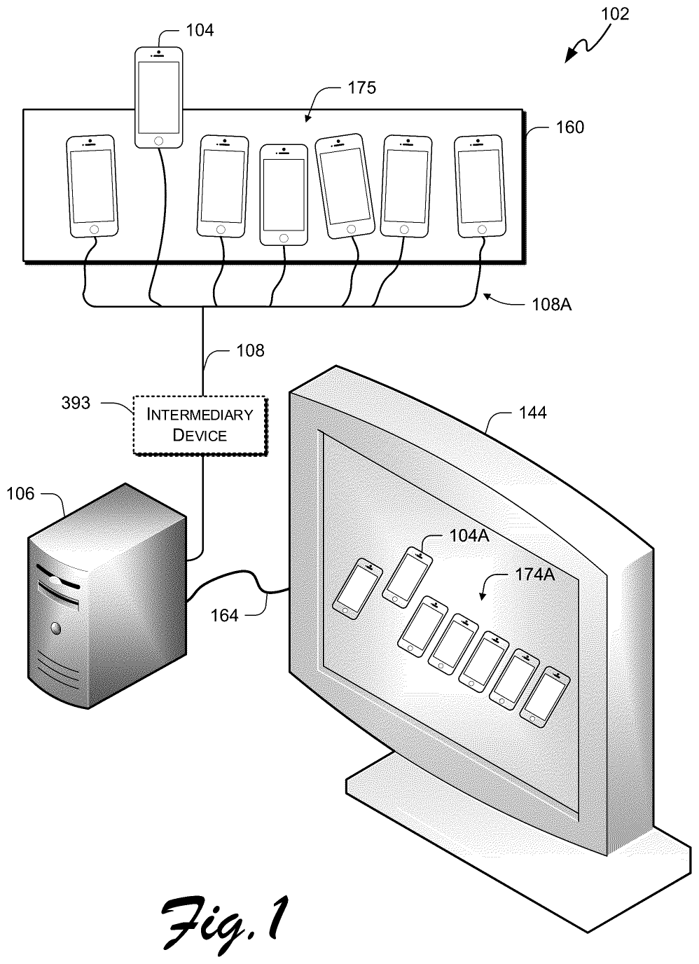

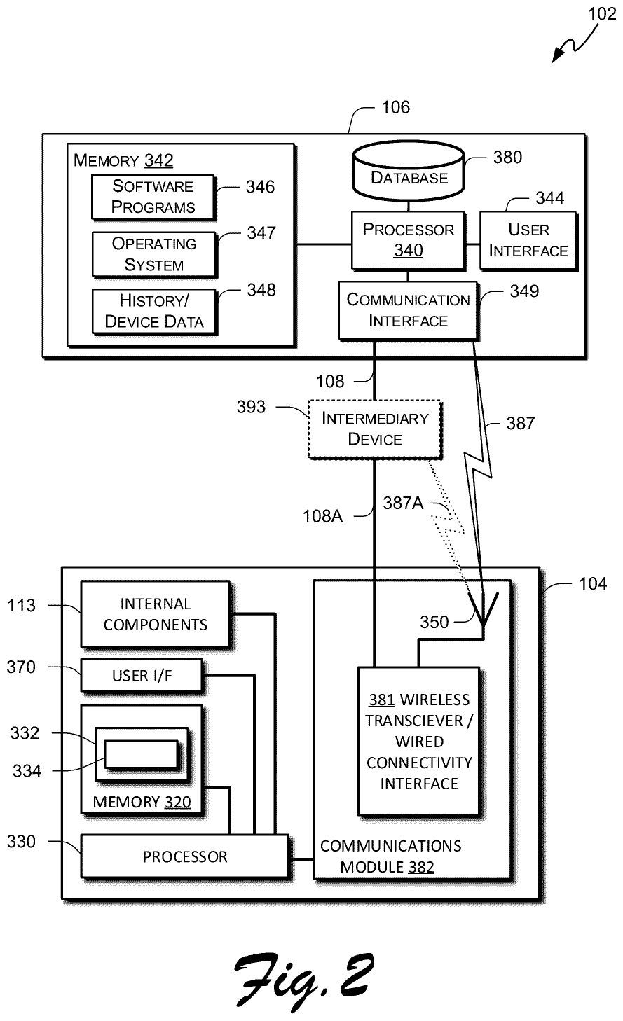

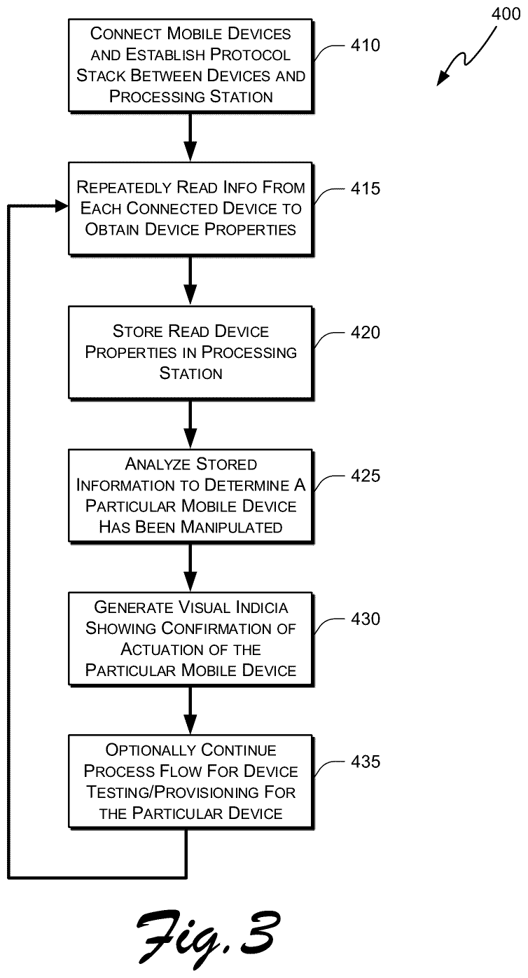

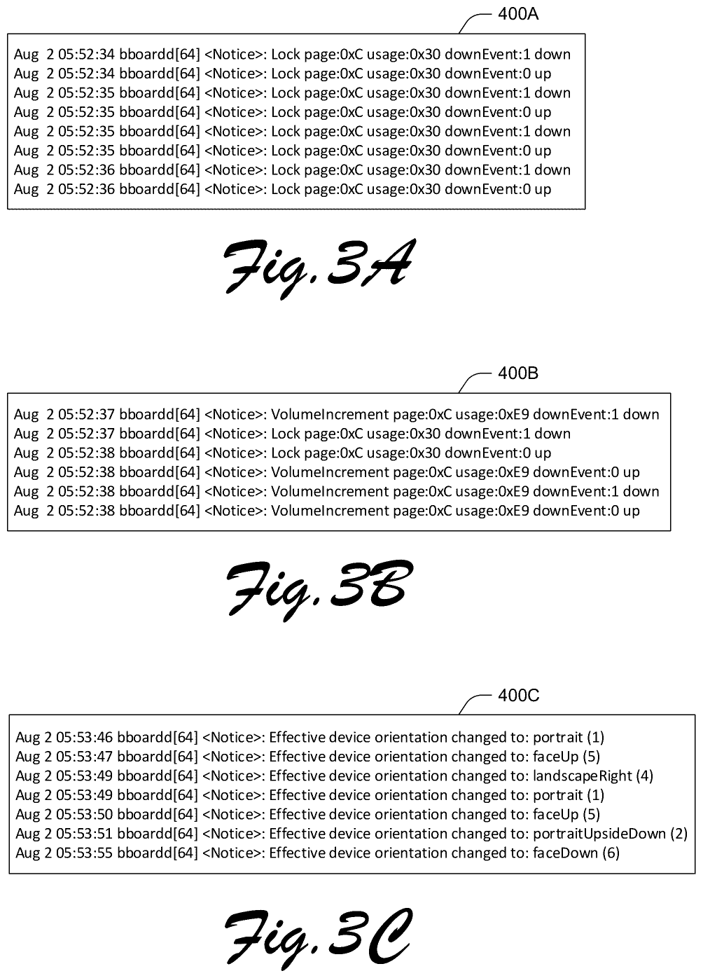

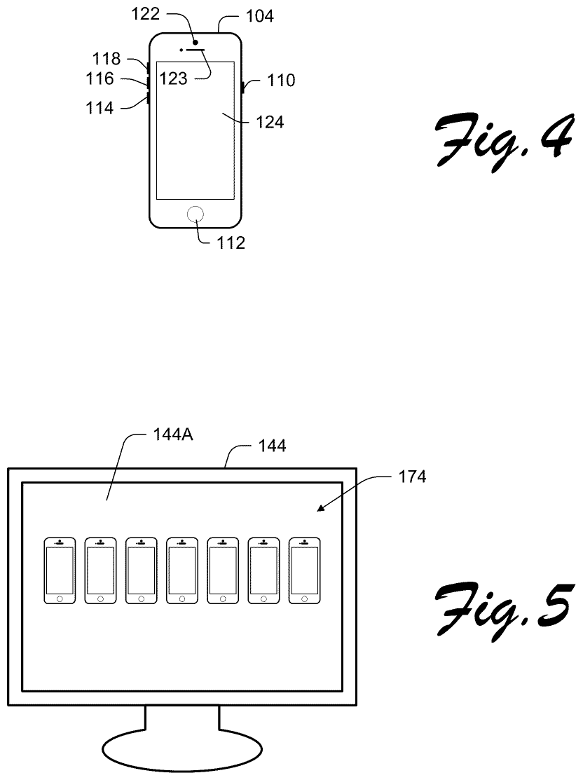

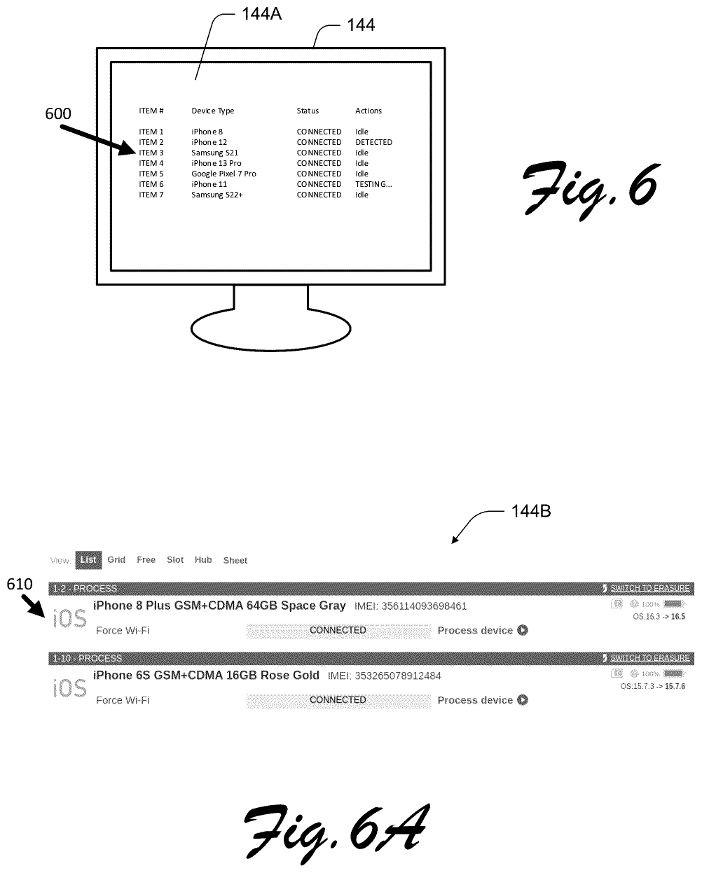

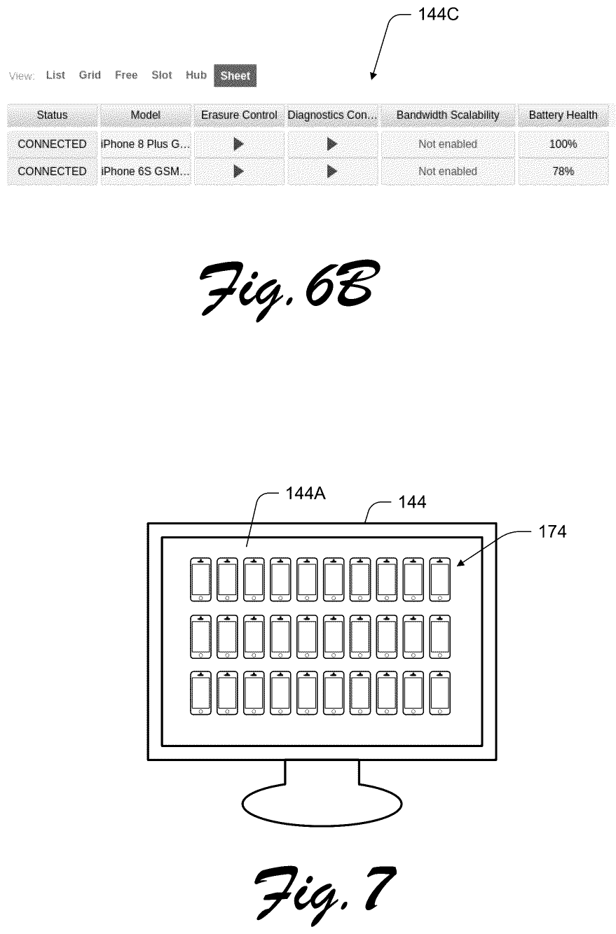

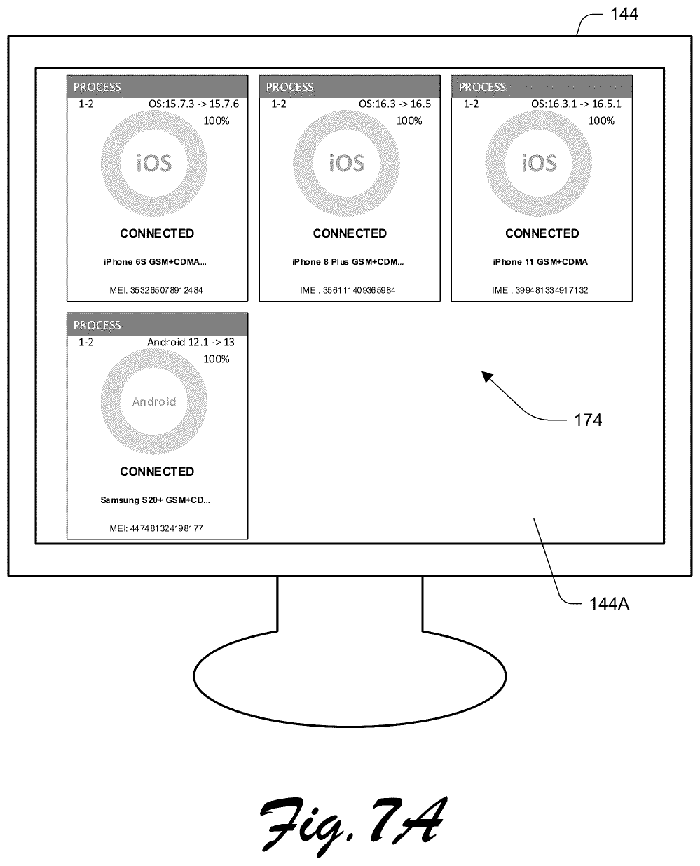

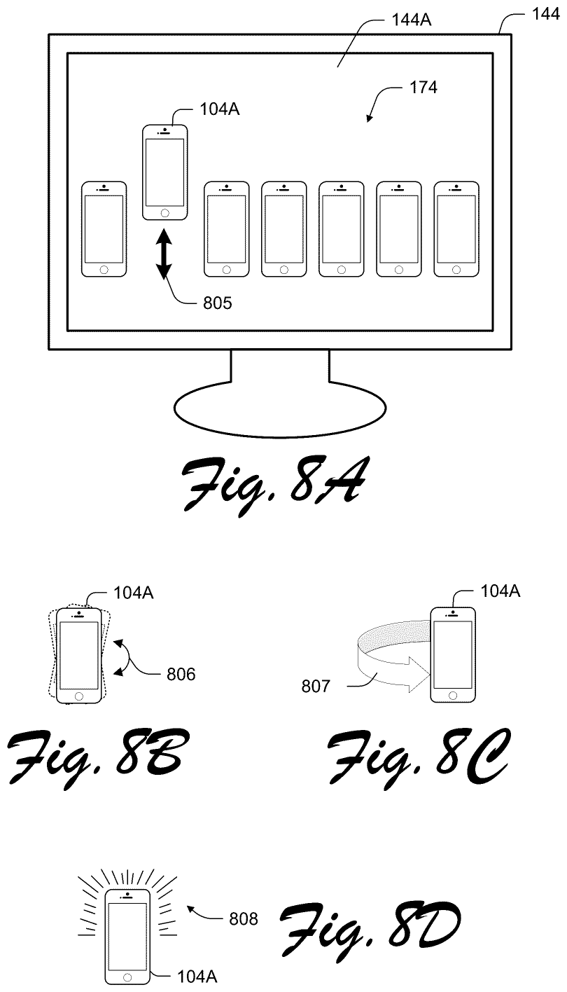

FIG. 1 illustrates a system embodiment 102 of the present invention for identifying a device connected to a processing station. A workbench 160 provides a stable platform for a plurality of mobile devices 175 (the plurality being inclusive of mobile device 104) that are undergoing procedures such as testing, erasure, and/or re-provisioning; and in one aspect, the workbench 160 provides sufficient stability for the mobile devices 175 deposited thereon to minimize movements/accelerations detected by accelerometers within each of the respective mobile devices 175. In the illustration, one of the mobile devices 104 is being lifted/manipulated by an operator (or alternatively, by a robotic device or other automated device) so that its internal accelerometers can detect the change of orientation (or one of its other input sources like a volume button may be manipulated by the operator). As mentioned above, mobile devices 175 may comprise any type of mobile electronic device (including devices as discussed above), and preferred embodiments may include mobile phones with either an Android or iOS operating system installed (although any other desired operating system may be used as well). The mobile devices 175 are respectively connected 108A to the processing station 106 through wired connections such as a USB or other protocols, and in one embodiment, the respective connections 108 may be coupled to an intermediary device 393 such as a USB hub, a switch, or a router, which is further coupled to the processing station 106. As will be discussed in more detail below in regards to FIG. 2, any or all of the mobile devices 175 may be wirelessly communicatively coupled to the processing station 106 though a wireless connection (387, or 387A). The processing station 106 is also communicatively coupled 164 to a display 144, which, in part, presents visual iconic representations 174 of the devices 175 on the workbench 160. In the illustrated embodiment, one icon 104A corresponding to mobile device 104 is illustrated as animated on the display 144 to indicate that the identified device 104 is being manipulated by the operator, thus assisting the operator with correct identification of the desired device on the workbench 160 and association with the correctly identified device in the processing station 106. Although the layout of devices 175 shown on the workbench 160 somewhat resembles the appearance of the icons 174 on the display 144, in many situations the devices 175 on the workbench may be arranged differently, arbitrarily, or in an order not indicated on the display 144, thus making identification of the device 104 by the icon 104A of great assistance when a large number of devices 175 are respectively disposed in proximity to one another on the workbench 160.

FIG. 2 shows a more detailed schematic block diagram of the system of FIG. 1, with the processing station 106 coupling to an exemplary mobile device 104 through one or more of a wired connection 108, a wireless and wired connection 387A/108 or a wireless connection 387. Wired connections may be achieved with any desired wired connection protocols including, for example, a USB connection, a wired serial connection, and a wired Ethernet connection. Likewise, mobile device 104 may be communicatively coupled to the processing station 106 through a wireless connection 387 (or, alternatively 387A) through protocols such as Wi-Fi, Bluetooth, Near Field Communication (NFC), infrared connections, or other protocols. For mobile devices that are wirelessly connected to the processing station 106, unique IP addresses may be respectively assigned and tracked by the processing station 106 to ensure software programs 346 being executed by the processor 340 may communicate individually with each of such respective wirelessly connected mobile devices. In various embodiments, the respective assigned IP addresses may further be mapped to respective USB ports to facilitate operation of communication channels between the processor 340 and the respective wirelessly connected mobile devices. While FIG. 2 shows the processing station 106 connected to a single exemplary device 104, in operation, the processing station is configured to concurrently host multiple of such connections to a respective plurality of mobile devices, such as the illustrated plurality of devices 175 in FIG. 1. The processing station 106 includes a processing resource in the form of a processor 340, which is respectively communicatively coupled to a memory 342, a communication interface 349, a user interface 344, and one or more an optional databases 380. The one or more databases 380 may store information regarding device features, capabilities, configurations, and diagnostic/provisioning information, procedures, and diagnostic/provisioning results.

The user interface 344 may include connections to any desired input devices to receive commands, data, and other suitable input from a user, operator and/or third party, as well as any number of output devices (including a screen such as the display 144 of FIG. 1) to provide the user/operator/third party with data, notifications, and other suitable information from the processing station 106. The communication interface 349 may be coupled to a network (not shown) to provide connectivity to the Internet and/or other external computing components such as remote servers. Among other things, the memory 342 stores a computer program 346 which, when executed by the processor 340, causes the processor 340 to perform methods such as those as described elsewhere herein.

The exemplary system depicted in FIG. 2 further comprises an exemplary mobile device 104 (and non-illustrated optional mobile devices as shown in the plurality 175 of FIG. 1), the mobile device 104 including a processing resource in the form of a processor 330, which is coupled to a memory 320 that may include volatile memory, nonvolatile memory (such as FLASH memory) or a combination thereof. The mobile device's memory 320 further includes a memory data structure 332, which, in some configurations, may store a debug log 334. In various implementations, memory data structure 332 may be implemented as a ring buffer (also known as a circular buffer).

The mobile device 104 includes a user interface 370 coupled to the processor 330. The user interface 370 may include any number of input devices (discussed in more detail with respect to FIG. 4 below) to receive commands, data, and other suitable input from a user, as well as any number of output devices (not shown) to provide the user with data, notifications, and other suitable information from the mobile device 104. The referenced internal components 113 may include any desired internal elements to support use of the mobile device, including one or more accelerometers, magnetometers, gyroscopes, haptic vibration or agitation devices, batteries, ports, jacks, inductive charging circuitry, GPS/geolocation circuitry, or any other desired sensors or transducers.

As also shown in FIG. 4, the user interface 370 may include one or more of several input elements in the form of an ON/OFF button or power key 110, a home/touch ID button 112, an internal accelerometer 113 (not illustrated in FIG. 4), a volume down button 114, a volume up button 116, a silent mode switch 118, a proximity sensor 122, a touchscreen 124, one or more internal microphones (not illustrated), and one or more cameras (not illustrated). The mobile device 104 includes output elements in the form of the touchscreen 124, one or more internal vibrators/agitators (not illustrated) and one or more internal speakers.

A communications module 382 comprises a wireless transceiver 381 for wirelessly communicating 387 with the processing station 106 and/or communicating 387A with optional intermediary device 393 or other entities through antenna 350, and those of skill in the art may appreciate that the discussed wired connections 108 may be established to provide connectivity in lieu of or in addition to the wireless connection. The mobile device 104 may include any suitable power source, such as a battery (not shown) or may receive power through a wired connection such as those shown in FIG. 1, 108A. Some or all of the components of the mobile device 104 may include (or be in communication with) a hardware identification module (not shown) such as a universal subscriber identity module and/or removable user identity module. The hardware identification module may be coupled to the processor 330 and may include an identifier that can be compared to a predetermined identifier to determine whether the hardware of the mobile device 104 has been altered. The hardware identification module (and predetermined identifier) may include any suitable identifier, such as an electronic serial number, a local area identity identifier, an integrated circuit identifier, an international mobile subscriber identifier, an authentication key identifier, and/or an operator-specific emergency number identifier. The identifier may be stored in the memory 320 and transmitted to the processing station 106 for comparison to a predetermined identifier.

The functionality of the mobile device 104, including the methods described herein (in whole or in part), may be implemented through the processor 330 executing computer-readable instructions stored in the memory 320 of the mobile device 104. The memory 320 may store any computer-readable instructions and data, including software applications, user-installed or third-party-installed “apps,” applets, and embedded operating code.

Software performing methods of the present invention may be provided with the device or downloaded onto the mobile device by an authorized user, and/or may be further resident in memory 342, 346 of the processing station 106 and executable by the processing station processor 340. The functionality of the mobile device 104 as well as the processing station 106 may also be implemented through various hardware components storing machine-readable instructions, such as application-specific integrated circuits (ASICs), field-programmable gate arrays (FPGAs) and/or complex programmable logic devices (CPLDs), graphics processing units (GPUs), and other circuits. Systems according to aspects of the present invention may operate in conjunction with any desired combination of software and/or hardware components as further described herein.

The mobile device processor 330 retrieves and executes instructions stored in the memory 320 to control the operation of the mobile device 104. Similarly the processing station processor 340 retrieves and executes instructions stored in the processing station memory 342 to control the operation of the processing station 106. Any number and type of processor such as an integrated circuit microprocessor, microcontroller, and/or digital signal processor (DSP), can be used in conjunction with the present invention. The memory 320 stores instructions, data, debug log records, messages calculated, stored, and/or transmitted from (or received by) the mobile device 104, and any other suitable information, and the processing station memory 342 similarly stores instructions, data, messages transmitted from (or received by) the processing station 106, and any other suitable information. A memory 320 and processing station memory 342 operating in conjunction with the present invention may include any combination of different memory storage devices, such as hard drives, random access memory (RAM), read only memory (ROM), FLASH memory, or any other type of volatile and/or nonvolatile memory. Data can be stored in the mobile device memory 320 or processing station memory 342 in any desired manner.

The communications module 382 communicates with one or more external entities such as processing station 106, or other suitable entities such as optional intermediary device 393. In like manner, the communication interface 349 of the processing station 106 is configured to communicate with the mobile device 104, a general network such as the Internet, or any other suitable entity. Any suitable communications device, component, system, and method may be used in conjunction with the present invention. For example, the transceiver 381 may be configured to communicate using any number and type of wireless protocols such as 802.11 Wi-Fi protocols, Bluetooth protocols, and/or cellular protocols, such as General Packet Radio Service (GPRS), Global System for Mobile Communications (GSM), Enhanced Data rates for GSM Evolution (EDGE), Personal Communication Service (PCS), Advanced Mobile Phone System (AMPS), Code Division Multiple Access (CDMA), Wideband CDMA (W-CDMA), Time Division-Synchronous CDMA (TD-SCDMA), Universal Mobile Telecommunications System (UMTS), and/or Time Division Multiple Access (TDMA). A mobile device 104 operating in conjunction with the present invention may alternatively (or additionally) include wireless transceiver(s) (and related components) to communicate using any other method of wireless communication protocol, such as an ISO 14443 protocol, an ISO 18000-6 protocol, a Bluetooth protocol, a Zigbee protocol, a Wibree protocol, a Wi-Fi protocol, an IEEE 802.15 protocol, an IEEE 802.11 protocol, an IEEE 802.16 protocol, an ultra-wideband (UWB) protocol; an IrDA protocol, and combinations thereof; and further, the communication interface 349 of processing station 106 may be configured to operate with such protocols to communicate with the mobile device 104 or any other device. The antenna 350 may be configured to transmit and receive any wireless signal in any format, and may comprise a plurality of different antennas to transmit and receive using different wireless protocols.

The communications module 382 of the mobile device 104 can communicate with the processing station 106 or another device using any other form of connection, such as a wired Internet connection, a wireless Internet connection, a cellular telephone network connection (including a data link connection), a wireless LAN connection, a wireless WAN connection, an optical connection, a Firewire connection, Thunderbolt connection, a Lightening port connection, an e-SATA connection, a USB connection, a mobile device synchronization port connection, a power connection, and/or a security cable.

Any number of input devices may be included in the user interfaces 370, 344 such as touch pads, touch screens, a mouse/trackball/trackpad, a microphone, and/or an alphanumeric keypad to allow a user to enter instructions and data into the mobile device 104 and processing station 106. The term “touch screen” for purposes of the present application may include a display integrated with or in close proximity to a touch interface that is capable of determining when a user applies physical connection to a location proximate the display. The touch screen may have sensors that can measure parameters from the user's interaction, and such sensors may measure capacitance, resistance, pressure, or differential readings resulting from movement of a “touch” to the screen. The user interface 370 may be configured to detect pressure exerted by a user on the keys of a keypad (virtually implemented on the display, or as a physical array of key switches), as well as the time interval between key presses in order to determine if the current user is authorized to use the device. The user interface 370 may also include a microphone to allow the user to provide audio data to the mobile device 104, as well one or more cameras to allow the mobile device to capture still or video images. Similarly, the user interface 344 of the processing station 106 may include a microphone to allow a user to provide audio data to the processing station 106, as well one or more cameras to allow the processing station 106 to capture still or video images. In one embodiment, the mobile device 104 comprises a front-facing camera (not shown) that faces the user when the device is in operation, and a rear-facing camera (not shown) on an opposite side of the mobile device. The mobile device 104 may include speech recognition software to process verbal input through the user interface 370. The user interface 370, and similarly the processing station user interface 344 may also include any number of suitable output devices, such as a display screen to visually display information (such as the display 144 shown on FIG. 1), and/or a speaker to provide auditory output. The display of the mobile device may be configured to sense user touches by any appropriate means, such as capacitive sensing, pressure sensing, gel displacement sensing, resistive sensing, or any other appropriate or conventional touch sending technology utilized by those of skill in the relevant arts. The mobile device 104 may be configured to provide words, phrases, tones, recorded music, or any other type of auditory output to a user through the speaker.

The mobile device 104 may include one or more biometric devices configured to receive biometric information, such as a fingerprint scanner, a facial recognition scanner, an iris scanner, a retinal scanner, and/or a breath analyzer. Input devices such as a microphone or camera may also be utilized to perform biometric analyses, such as a voice analysis or facial recognition. Further, the mobile device 104 may include a magnetometer for measuring magnetic fields (such as may be utilized in an electronic compass), a MEMS or other type of gyroscope for measuring attitude, and accelerometers for measuring changes in movement of the mobile device.

The user interfaces 370, 344 can also provide/receive information to a user in a machine-readable format. In one exemplary embodiment of the present invention, for example, the user interface 370 of a mobile device 104 may send and receive messages using dual-tone multi-frequency (DTMF) tones. The mobile device 104 and processing station 106 can be configured to send, receive, and process machine-readable data in any standard format (such as a MS Word document, Adobe PDF file, ASCII text file, JPEG, or other standard format) as well as any proprietary format. Machine-readable data to or from the user interfaces 370, 344 may also be encrypted to protect the data from unintended recipients and/or improper use. Any other user interface feature may be utilized to allow a human or non-human user to interact with one or more devices operating in conjunction with the present invention.

One of ordinary skill in the art will understand that, in use, the processor 330 runs an operating system (OS) such as the iOS operating system or the Android operating system, although other mobile device operating systems may be utilized as desired.

FIG. 3 shows an exemplary high-level flow diagram 400 depicting a method of the present invention, and is further appreciated in view of FIGS. 1-2. In step 410, one or more mobile devices (such as devices 175 of FIG. 1) are connected either directly to a processing station 106 or indirectly through an intermediary device 393, and protocol stacks are established 410 by the processing station processor 340, supporting communication between the respective mobile devices 175 and the processing station 106. Once the connections and protocol stacks are established, information is repeatedly read 415 from each of the connected mobile devices 175 to obtain device properties from the respective devices.

In one exemplary embodiment, with an exemplary mobile device 104 configured in normal mode, the OS of the mobile device 104 repeatedly receives information relating to the status, activation and/or operation of the hardware elements 110, 112, 113, 114, 116, 118, 122, 124 and writes the received information to the debug log 334 stored in the data structure 332 via a syslog relay service. When the mobile device 104 is connected to the processing station 106 via the cable 108A/108 (or wirelessly coupled) and the processor 340 of the processing station 106 executes the computer program 346, the processor 340 of the processing station 106 repeatedly reads information from the debug log 334 stored in the data structure 332 of the mobile device 104, the processor 340 repeatedly uses the information read from the debug log 334 to construct, store 420 and maintain device properties and an event history for the mobile device 104 in the processing station memory 348, and the processor 340 repeatedly determines a status of the mobile device 104 based on the stored properties/event history. Examples of monitored events regarding properties of the connected mobile device 104 are shown in FIGS. 3A-3C. More particularly, FIG. 3A shows an exemplary table of events data (one line per event) obtained from a connected mobile device, showing when a power button of the mobile device had been pressed and released four times. Further, FIG. 3B shows an exemplary table of events data obtained from a connected mobile device, showing when a power button and a volume down button of the mobile device had been pressed and released. Additionally, FIG. 3C shows an exemplary table of events data obtained from a connected mobile device, showing when the mobile device's orientation has been changed to various positions. A device identifier is stored along with the device properties and event history, allowing the stored device properties and event history to be associated with a particular device (such as mobile device 104) that is connected to the processing station 106 along with a plurality 175 of mobile devices.

More specifically, in one embodiment, when the processor 340 of the processing station 106 executes the computer program stored in memory 346, the processor 340 repeatedly reads information from the debug log 334 stored in the data structure 332 of the mobile device 104 at a plurality of different instants in time, wherein any two successive instants in time are separated by a time period which is sufficiently small so as to avoid the OS of the mobile device 104 from over-writing any information in the debug log 334 stored in the data structure 332 before the processor 340 can read the information. In one aspect, when the processor 340 of the processing station 106 executes the computer program stored in memory 346, the processor 340 obtains the contents of the debug log 334 stored in the data structure 332 of the mobile device 104 by executing an “idevicesyslog” command. The processor 340 reads only the information from the debug log 334 stored in the data structure 332 at one instant in time which is new or additional to the information which the processor 340 reads from the debug log 334 at a preceding instant in time. By proceeding in this way, there is no need for the processor 340 to repeatedly read the whole debug log 334 at each instant in time. The processor 340 uses the information which is repeatedly read from the debug log 334 to construct and maintain an event history for the mobile device 104 which includes an event history of each of the hardware elements 110, 112, 113, 114, 116, 118, 122, 124. The event history for the mobile device 104 may also include any errors or warnings which the OS of the mobile device 104 has encountered or generated during execution of the computer program stored in memory 346.

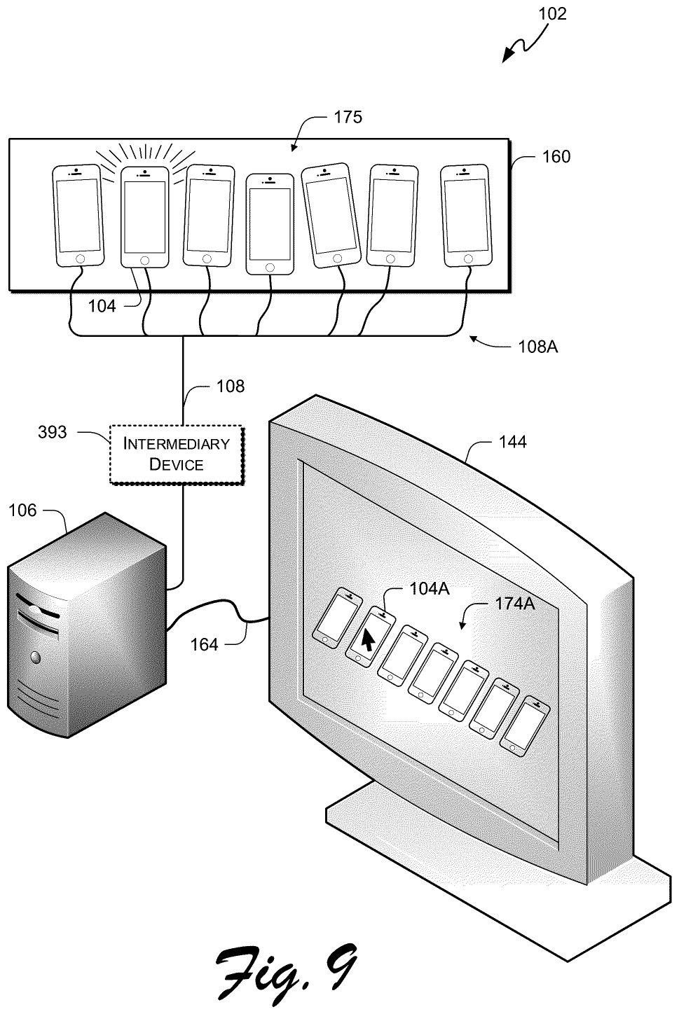

The processor 340 repeatedly searches the event history to identify any entries in, portions of, or lines of code of, the event history which contain one or more characters, one or more symbols, one or more keywords, or one or more commands associated with at least one of the status, the activation and/or the operation of each hardware element 110, 112, 113, 114, 116, 118, 122, 124. For example, the processor 340 repeatedly executes a “grep” command for each of the hardware elements 110, 112, 113, 114, 116, 118, 122, 124 of the mobile device 104 to repeatedly search the event history and identify any entries in, portions of, or lines of code of, the event history which contain one or more characters, one or more symbols, one or more keywords, or one or more commands associated with at least one of the status, the activation and/or the operation of each hardware element 110, 112, 113, 114, 116, 118, 122, 124. The processor 340 repeatedly determines the status of each hardware element 110, 112, 113, 114, 116, 118, 122, 124 from the corresponding entries in, portions of, or lines of code of, the event history identified during the search. For example, the processor 340 repeatedly determines the status of each hardware element 110, 112, 113, 114, 116, 118, 122, 124 by repeatedly parsing the corresponding lines of code of the event history identified during the search. As illustrated in FIGS. 5, 6, 6A, 6B, 7, 7A, and 8A-8C, the processor 340 causes the display 144 of the processing station 106 to repeatedly update the respective graphical representations 174, 104A of the mobile devices 175, 104 and the textual representations 600, 610, 144C of the mobile devices 104, 175 to provide graphical and/or textual indicia to show on the display 144 that a particular mobile device 104 is being manipulated. Optionally, on the display screen 144A of display 144, the processor 340 causes an update of including the graphical and/or textual representations of each device and/or hardware element 110, 112, 113, 114, 116, 118, 122, 124 according to the determined status of each hardware element 110, 112, 113, 114, 116, 118, 122, 124. At the instant in time corresponding to FIGS. 8A-8D, a sensed manipulation of mobile device 104 from any of its hardware elements 110, 112, 113, 114, 116, 118, 122, 124 that have changed status relative to the instant time corresponding to FIGS. 5, 6, 6A, 6B, 7, 7A, the processor 340 causes the display 144 of the processing station 106 to update the graphical representation of the iconic or textual 600, 610, 144C of the mobile devices 104, 175 to provide graphical and/or textual indicia to show on the display 144 that a particular mobile device 104 is being manipulated. As discussed in more detail below, a visual indicia is generated that can involve changing an iconic representation of the mobile device on the display 144 or highlighting/identifying a textual representation of the manipulated mobile device 104 on the display. Additional indicia such as pointers, arrows or other graphical elements may be rendered on the screen 144A to identify a particular iconic or textual representation of the mobile device 104 that is being manipulated.

Continuing with the flow diagram of FIG. 3, the processor 340 of the processing station 106 then analyzes 425 the information stored in the processing station memory 348 to determine that a particular mobile device has been manipulated 425. This determination may be made by any desired technique, such as analyzing the stored information in the debug log and determining a recent change in a device property has occurred. The manipulation may include any function affecting the operation of one of the connected mobile devices 175, including an operator performing one or more of changing orientation of the manipulated mobile electronic device through lifting and/or turning the manipulated mobile electronic device, pressing a volume button on the manipulated mobile device, tapping an area of a display of the manipulated mobile electronic device, pressing a home/touch ID button of the manipulated mobile electronic device, pressing an off/on button of the manipulated mobile electronic device, covering a proximity sensor location of the manipulated mobile electronic device, and removal and/or replacement of the manipulated mobile electronic device from a wireless charging pad.

The determination of recent change may be triggered by the processing station processor 340 identifying a sliding event timing window and reviewing events within that timing window to determine that a particular device property has changed from its previous state by more than a predetermined amount or percent, comparing the particular device property to determine that it exceeds a predetermined threshold, or analyzing the particular device property to determine that the property deviated from a threshold by a particular amount. In an alternate embodiment, the workbench 160 may experience shaking, vibrations, or other mechanical noise in a busy workplace environment that may show changes in device properties for several or all devices 175 disposed on the workbench 160, as multiple of the devices 175 may register accelerometer property changes as a result of accelerations, impacts or vibrations to the workbench 160. As such, an alternate embodiment may suppress the “noisy” receipt of accelerations by the devices 175 by comparing respective properties of multiple connected devices 175 and determining that the respective properties were modified within a predetermined timing window, thus likely as a result of receiving coupled near-simultaneous accelerations from the workbench 160 surface. In such an embodiment, changes in multiple device properties may be categorized in a range identified as a noisy event, and only a device property of one of the connected multiple devices 175 that exceeds this noisy event range may be considered as being potentially manipulated.

Next, once a particular mobile device of the connected mobile devices 175 has been identified as being manipulated (for example, device 104 as shown in FIG. 1), a visual indicia is generated 430 showing confirmation of actuation of the manipulated mobile device 104. As illustrated in specific embodiments shown in FIGS. 8A-8D, several alternative embodiments of visual indicia are illustrated for the icon-based row display on the screen 144A of FIG. 8A. The display 144, may be modified by the processing station processor 340 to indicate that a device has been picked up or otherwise manipulated; for example, FIG. 8A shows animating/moving 805 the icon 104 up and down, FIG. 8B shows a “wobble” 806 of the icon, FIG. 8C depicts a rotation 807 about a vertical axis, and FIG. 8D represents changing highlighting/brightness and/or color of the icon when the mobile device is manipulated. Those of skill in the art appreciate that other visual indicia techniques may be applied to indicate that an icon corresponding to a manipulated mobile device 104 identifies manipulation of the corresponding device 104. Further, in an alternative embodiment, after a predetermined time with no further manipulation of the mobile device 104, further operations and visual indicia will be halted, indicating that the mobile device 104 is being returned to its previous state, and the display screen 144A will be updated to show the manipulated mobile device 104 is no longer being manipulated. Additionally any of the of iconic/textual representations 174, 600, 610, 144C on the display 144 of the connected mobile devices 175 may be animated/varied by the processor 340 in any of the techniques discussed in regards to FIGS. 8A-8D.

Once a visual indicia has been generated 430, additional optional actions may take place 435, either automatically, with prompted confirmation by the operator, or both, for example, to perform or continue diagnostic testing of the manipulated mobile device 104 or to perform a provisioning operation such as an update of an operating system or memory erasure of the manipulated mobile device 104. More specifically, options may include prompting the operator to confirm selection of the device for initiation of a diagnostic or re-provisioning procedure, automatically initiating a diagnostic or re-provisioning procedure for the manipulated electronic mobile device upon determining that the manipulated electronic mobile device had a change in one of its device properties, or causing the processing station to pause further operation of a predetermined process flow until upon determining that the manipulated electronic mobile device had a change in one of its device properties. Further, the operator may be prompted by the processing station 106 to operate one or more features of the manipulated mobile electronic device as part of a diagnostic procedure, such as pressing a volume button 114, 116 on the manipulated mobile electronic device 104, tapping an area of a touchscreen 124 of the manipulated mobile electronic device 104, tapping any portion of the manipulated mobile device 104 to impart a vibration and/or acceleration thereto, pressing a home/touch ID button 112 on the manipulated mobile electronic device 104, changing orientation of the manipulated mobile electronic device 104, pressing an off/on button 110 of the manipulated mobile electronic device 104, covering a proximity sensor location 122 of the manipulated mobile electronic device 104, or removal and/or replacement of the manipulated mobile electronic device 104 to a wireless charging source.

In an alternative embodiment of step 435, the operator may be prompted, through a prompt on the screen 144A of the display 144 of the processing station 106 or through the touchscreen 124 of the manipulated mobile device 104 to initiate diagnostics or provisioning/erasure by tapping/shaking and/or moving the mobile device to confirm the continued operation. Likewise a mouse click to a button on the display 144 of the processing station 106 may be used to confirm the continued operation.

As non-limiting examples of process 400, FIGS. 8A, 8B, 8C, and 8D illustrate graphical depictions of the activation of the accelerometer 113 of the manipulated mobile device 104 by an operator rotating the mobile device 104, for instance, though approximately 90° from a “portrait orientation” to a “landscape orientation.” The detection of the activation of the accelerometer 113 by the processor 340 of the processing station 106, and how the processor 340 updates the graphical representation 104A of the mobile device 104 on the display 144 of the processing station 106 to show the live status 174 of connected mobile devices 175, and in the particular, the manipulated mobile device 104 by animations

While FIGS. 8A, 8B, 8C, and 8D show graphical iconic representation 104A of the mobile device 104 on the display 144 of the processing station 106 at an instant in time just after any of the hardware elements 110, 112, 113, 114, 116, 118, 122, 124 of the mobile device 104 have been activated, such as by the operator rotating the mobile device 104 to a landscape orientation and after the graphical representation 104A of the mobile device 104 on the display 144 of the processing station 106 has been updated, but before completion of the re-orientation of the image displayed on the touchscreen 224 of the mobile device 104 from “landscape” to “portrait.” One of skill in the art will understand that the processor 340 determines that the accelerometer 113 of the mobile device 104 has detected the re-orientation of the mobile device 104 from the “landscape orientation” to the “portrait orientation” based on the information read from the debug log 334 in essentially the same way that the processor 340 determines that the power key 110 of the mobile device 104 has been activated based on the event history as described above. Moreover, the processor 340 determines that the accelerometer 113 of the mobile device 104 has detected the re-orientation of the mobile device 104 from the “landscape orientation” to the “portrait orientation” and updates the graphical representation 104A of the mobile device 104 on the display 144 of the processing station 106 to the pre-manipulation states shown in FIGS. 5, 6, 6A, 7, and 7A.

Although not described above, one of ordinary skill in the art will understand that when the computer program stored in memory 346 is executed by the processor 340, the processor 340 may detect the status, activation and/or operation of any of the hardware elements 110, 112, 113, 114, 116, 118, 122, 124 and update the graphical representation 104A of the mobile device 104 or a textual representation 600, 610, 144C on the display 144 of the processing station 106 accordingly using a method which is essentially identical to the methods described above with reference FIG. 3.

It should be understood that the methods for use in determining the status of the mobile device 104 described above do not require the installation and/or execution of a diagnostic application on the mobile device 104 and can therefore be used even when it is not technically possible to install and/or execute a diagnostic application on the mobile device 104 e.g. as a consequence of lack of memory available on the mobile device 104. The methods described above may avoid any requirement to receive information indirectly from the OS of the mobile electronic device via the APIs of the OS. Additionally or alternatively, the methods described above may avoid any restrictions imposed by the manufacturer of the mobile device 104 and/or a manufacturer of the OS of the mobile device 104, which restrictions may prohibit the installation and/or execution of a third-party diagnostic application on the mobile device 104. Furthermore, the methods described above can still be applied even if the mobile device 104 has one or more broken controls, one or more broken push buttons, a broken touchscreen, and/or one or more broken sensors which may prevent a user of the mobile device 104 from navigating to, or executing, a diagnostic application and/or which may prevent a user of the mobile device 104 from inputting and/or receiving instructions from the mobile device 104.

Whether or not the optional step 425 of the flow diagram in FIG. 3 is executed, processing continues 415 to again repeatedly read information from the connected devices 175 to determine whether a particular device is being manipulated, and the process flow continues above as desired. Optionally, not illustrated, other mobile devices may be connected at any time to the processing station 106 or one of the connected devices 175 removed as desired, and the processing step 410 adjusts the protocol stacks to reflect the most current connection configurations.

FIGS. 5, 6, 6A, 7, and 7A illustrate alternative ways to show connected mobile devices 175 on the processing station's display 144, including various display elements showing iconic/graphical representations 174 of the connected mobile devices 175, or textual representations 600, 610, 144C of connected mobile devices 175. These figures depict display 144 and/or screen 144A, at a point in time when connected devices 175 are deposited on the workbench 160 and are not being actively manipulated by an operator. FIG. 5 shows a display 144 of the primary system, with the collection of icons 174 representing the plurality of connected mobile devices 175, on the screen 144A. This illustration shows a simple linear arrangement of icons.

FIG. 6 illustrates a textual list-based arrangement 600 of information regarding mobile devices 175 connected to a processing station of the present invention. The text list 500 may include any desired information at any desired level of detail, and individual textual elements may be highlighted, changed font size or formatting such as bold/italic/underlined, zoomed in our out, shown as located in a box or other object, or pointed to by a visual icon such as a pointer cursor when a visual indicia is desired to highlight the particular textual item corresponding to manipulated mobile device 104. Further, FIG. 6A shows an alternate aspect showing a subset illustration of an embodiment of the list-based arrangement of information as shown in FIG. 6, where additional details may be included, such as the operating system type, a more detailed description of the attached mobile devices 175, identifying information such as an IMEI number, battery charge status, and other desired information. In an additional aspect, the attached mobile devices 175 may be presented 144C on the screen 144A of display 144 as textual representations in a sheet or spreadsheet format shown in FIG. 6B.

FIG. 7 illustrates a grid-based arrangement of visual icons on a screen according to an embodiment of the present invention. Icons representing connected mobile devices 175 are shown arrayed 174 on the display screen 144A in a grid format. FIG. 7A shows an alternative embodiment of the grid-based arrangement of visual icons on a screen of FIG. 7, with more detail shown in icons 174 corresponding, in the illustrated case, to four connected mobile devices 175. The icons 174 of FIG. 7A provide a graphical iconic representation of the connected mobile devices 175 while offering a summary of details including OS type, connection status, device type, IMEI identifying information, OS version, battery charge state, and any other desired information. Each of these respective icons may be individually visually identified with similar techniques similar to those shown in FIGS. 8A-8D.

FIG. 8A illustrates a linear displacement animation of visual icons 174 on a screen 144A of display 144 according to an embodiment of the present invention, and FIGS. 8B-8D respectively illustrate a wobbling animation, a rotation animation about a vertical axis, and a change of visual characteristic such as brightness, hue, or color of visual icons on a screen according to an embodiment of the present invention, and are discussed more fully above in regards to FIG. 3.

FIG. 9 illustrates another system embodiment of the present invention, showing identification of a connected mobile device 104 by hovering a mouse over its corresponding icon 104A on a display 144 coupled to the processing station 106, or clicking on an area of the corresponding icon 104A. Illustrated hardware is similar to that described above in accordance with FIG. 1; for example, the mobile devices 175 are respectively connected 108A to the processing station 106 through wired connections such as a USB or other protocols, and in one embodiment, the respective connections 108 may be coupled to an intermediary device 393 such as a USB hub, a switch, or a router, which is further coupled to the processing station 106. Further, in this embodiment, an exemplary process represents a partial reverse process as discussed in accordance with FIG. 3, where on the display 144, a cursor (shown as black arrow) is hovered and/or clicked over an icon of interest 104A, and the processing station 106 performs commands to cause the mobile device 104 disposed on the workbench 160 to create an output perceivable by an operator, such as a brief flash (as shown on device 104 on the workbench 160), a vibration, or audio announcement. In this embodiment, such outputs may be possible without first installing an app on the mobile device 104, or alternatively, an app may have first been installed on device 104 to facilitate remote operation of output devices of the mobile device 104 by the processor 340 of the processing station 106.

In one embodiment, when mobile device 104 is communicatively connected to the processing station 106 either through a wired connection or wirelessly with an assigned IP address, software being executed in the processing station 106 is configured to receive input from a hover or a mouse click over icon 104A corresponding to the connected mobile device 104, and a command is then sent via the USB port/wireless IP address by the processing station 106 to the connected mobile device 104. Such commands may include instructions for connected mobile device 104 to turn on flash or actuate a vibration/agitator device; again, such commands are transmitted from the processing station 106 via a wired connection such as through a USB port, or wirelessly to an assigned IP address which is mapped to that port. In one aspect, commands may include addressing the accessibility settings of the connected mobile device 104 to actuate display, vibrator/agitator, or other functions without the need to directly access internal components; non-limiting examples include inverting display colors or enabling voice-over functions, among other options.

One of ordinary skill in the art will understand that various modifications are possible to the system and methods described above. For example, although the foregoing methods are described in the context of a mobile device such as an Apple iPhone®, it should be understood that the same methods may be applied to a mobile electronic device of any kind, for example to other types, kinds or makes of mobile phone or smartphone, to a tablet and/or to a laptop. In particular, it should be understood that the same methods may be applied to a mobile electronic device running an operating system other than an iOS operating system. For example, the same methods may be applied to a mobile electronic device running an Android operating system.

The method may comprise setting, controlling or enabling the mobile electronic device 104 so as to increase a level of detail of the information relating to the operation of the mobile electronic device 104 which the operating system of the mobile electronic device 104 writes to the debug log 334 stored in the data structure 332 of the mobile electronic device 104.

The method may comprise setting, controlling or enabling the mobile electronic device 104 so as to cause the operating system of the mobile electronic device 104 to perform verbose logging.

The mobile electronic device 104 may comprise an iOS device or an iOS operating system. The method may comprise using the syslog relay service when the mobile electronic device 104 is in normal mode.

The mobile electronic device 104 may comprise an Android device or an Android operating system. The method may comprise enabling USB debugging.

The mobile electronic device 104 may comprise more or fewer hardware elements than the hardware elements described above. For example, the mobile electronic device 104 may comprise at least one of a microphone, an image sensor and a speaker.

The particular implementations shown and described above are illustrative of the invention and its best mode and are not intended to otherwise limit the scope of the present invention in any way. Indeed, for the sake of brevity, conventional data storage, data transmission, and other functional aspects of the systems may not be described in detail. Methods illustrated in the various figures may include more, fewer, or other steps. Additionally, steps may be performed in any suitable order without departing from the scope of the invention. Furthermore, the connecting lines shown in the various figures are intended to represent exemplary functional relationships and/or physical couplings between the various elements. Many alternative or additional functional relationships or physical connections may be present in a practical system.

Changes and modifications may be made to the disclosed embodiments without departing from the scope of the present invention. These and other changes or modifications are intended to be included within the scope of the present invention, as expressed in the following claims.

What is claimed is:

1. A method for identifying a particular electronic device among a plurality of mobile electronic devices connected to a processing station, the method comprising:
establishing a protocol stack and respective connections between the plurality of mobile electronic devices and the processing station;
repeatedly reading information from each of the plurality of connected mobile devices, the information comprising device properties respectively associated with each of the respected connected mobile devices;
storing the read information in a memory of the processing station;
analyzing the read information to determine that a manipulated electronic mobile device of the plurality of connected mobile devices had a change in one of its device properties; and
generating a visual indicia showing confirmation of actuation of the corresponding manipulated mobile electronic device through a visual representation on a display of the processing station.

2. The method as claimed in claim 1, wherein generating a visual indicia further comprises visually animating on the display an iconic representation corresponding to the manipulated electronic mobile device for a predetermined period of time.

3. The method as claimed in claim 2, further comprising one or more of:
changing a brightness characteristic of the iconic representation;
changing a color characteristic of the iconic representation; and
displaying text adjacent to the iconic representation corresponding to identification of a device type corresponding manipulated mobile electronic device.

4. The method as claimed in claim 1, wherein manipulating one of the connected electronic mobile devices includes an operator performing one or more of:
changing orientation of the manipulated mobile electronic device through lifting and/or turning the manipulated mobile electronic device;
pressing a volume button on the manipulated mobile device;
tapping an area of a display of the manipulated mobile electronic device;
pressing a home/touch ID button of the manipulated mobile electronic device;
pressing an off/on button of the manipulated mobile electronic device;
covering or approaching a proximity sensor location of the manipulated mobile electronic device; and
removal and/or replacement of the manipulated mobile electronic device from a wireless charging pad.

5. The method as claimed in claim 1, further comprising:
prompting the operator to confirm selection of the device for initiation of a diagnostic or re-provisioning procedure; or
automatically initiating a diagnostic or re-provisioning procedure for the manipulated electronic mobile device upon determining that the manipulated electronic mobile device had a change in one of its device properties; or
causing the processing station to pause further operation of a predetermined process flow until upon determining that the manipulated electronic mobile device had a change in one of its device properties.

6. The method as claimed in claim 1, further comprising prompting the operator, by the processing station, to operate specific features of the manipulated mobile electronic device as part of a diagnostic procedure, the operation of specific features including one or more of:
pressing a volume button on the manipulated mobile electronic device;
tapping an area of a display of the manipulated mobile electronic device;
tapping any portion of the manipulated mobile device to impart an acceleration thereto;
pressing a home/touch ID button on the manipulated mobile electronic device;
changing orientation of the manipulated mobile electronic device;
pressing an off/on button of the manipulated mobile electronic device;
covering a proximity sensor location of the manipulated mobile electronic device; and
removal and/or replacement of the manipulated mobile electronic device with a wireless charging source.

7. The method as claimed in claim 1, wherein the one or more of the plurality of mobile devices is connected to the processing station through a wired connection.

8. The method as claimed in claim 7, wherein the wired connection comprises one or more of a USB connection, a Lightning port connection, or a serial port connection.

9. The method as claimed in claims 1, wherein one or more of the plurality of electronic mobile devices is connected to the processing station through a wireless connection.

10. The method as claimed in claim 9, wherein the wireless connection comprises one or more of:
a Wi-Fi connection,
a Bluetooth connection,
a near-field communications connection,
an infrared connection, or
a cellular telephony connection.

11. The method as claimed in claim 1, wherein the display of the processing station further comprises a graphical user interface depicting a plurality of graphical representations respectively corresponding to each of the connected plurality of mobile devices.

12. The method as claimed in claim 11, wherein all graphical representations corresponding to each of the non-manipulated electronic devices are shown in a darker grayed-out depiction compared to the graphical representation corresponding to the manipulated electronic device.

13. The method as claimed in claim 1, wherein upon the corresponding manipulated electronic device being identified by the processing station, providing a confirmation indicia to be displayed and/or annunciated on the manipulated electronic device.

14. The method as claimed in claim 1, further comprising initiating, by the processing station, a test or provisioning process on the manipulated mobile electronic device that had a change in one if its device properties.

15. The method as claimed in claim 1, wherein repeatedly reading information from each of the plurality of connected mobile devices further comprises
repeatedly reading information from a debug log stored in a respective data structure of a respective memory of each of the connected mobile devices and storing the read information in a memory of the processing station respectively associated with an identifier respectively regarding each connected mobile device;
repeatedly using the information read from the debug log to construct and maintain event histories for each respective connected mobile device in the memory of the processing station; and
repeatedly determining the status of each of the connected mobile electronic devices based on the stored event history.

16. The method as claimed in claim 15, further comprising reading information from the stored debug log at a plurality of different instants in time, wherein any two successive instants in time are separated by a time period which is sufficiently small so as to avoid an operating system of the mobile electronic device from over-writing any information in the debug log stored in the respective memory before the information can be read.

17. The method as claimed in claim 15, further comprising repeatedly reading information from the debug log at regular intervals.

18. The method as claimed in claim 15, further comprising reading only information from the debug log stored in the data structure at one instant in time which is new or additional to the information read from the debug log at a preceding instant in time.

19. The method as claimed in claim 15, further comprising:
repeatedly identifying one or more entries in, or portions of, the event history which are associated with at least one of the status, the activation and/or the operation of a hardware element of the mobile electronic device; and
repeatedly determining the status of the hardware element based on the identified one or more entries in, or portions of, the event history.

20. The method as claimed in claim 19, wherein repeatedly identifying the one or more entries in, or portions of, the event history which are associated with at least one of the status, the activation and/or the operation of the hardware element comprises repeatedly searching the event history for at least one of one or more characters, one or more symbols, one or more keywords, and one or more commands associated with at least one of the status, the activation and/or the operation of the hardware element.

21. The method as claimed in claim 19, further comprising:
repeatedly parsing the identified one or more entries in, or portions of, the event history; and
repeatedly determining the status of the hardware element based on the one or more parsed entries in, or portions of, the event history.

22. The method as claimed in claim 19, wherein the hardware element comprises at least one of: a transducer, a component, a device, an input element, an output element, a control, a push button, a knob, a switch, a key, a keyboard, a keypad, a sensor, an accelerometer, an image sensor, a microphone, a proximity sensor, a motion sensor, a user interface, a touchscreen, an indicator, a display, and a speaker.

23. The method as claimed claim 1, further comprising setting, controlling or enabling the mobile electronic device so that an operating system of the mobile electronic device writes information relating to the operation of the mobile electronic device to the debug log stored in the data structure of the mobile electronic device.

24. The method as claimed in claim 1, further comprising:
setting, controlling or enabling the mobile electronic device so as to increase a level of detail of the information relating to the operation of the mobile electronic device which the operating system of the mobile electronic device writes to the debug log stored in the data structure of the mobile electronic device; and/or
setting, controlling or enabling the mobile electronic device so as to cause the operating system of the mobile electronic device to perform verbose logging.

25. The method as claimed in claim 1, wherein one or more of the plurality of mobile electronic devices comprises an iOS device or an iOS operating system and the method comprises using the syslog relay service when the mobile electronic device is in normal mode.

26. The method as claimed in claim 1, wherein one or more of the plurality of mobile electronic devices comprises an Android device or an Android operating system and the method comprises enabling USB debugging.

27. The method as claimed in claim 1, further comprising using an external processing resource of the processing station which is external to the plurality of connected mobile devices to repeatedly read information from the debug log stored in the data structure of each of the connected mobile devices.

28. The method as claimed in claim 27, further comprising using the external processing resource to cause the display of the processing station to repeatedly display information representative of the determined status of each of the connected mobile devices.

29. The method as claimed in claim 28, further comprising using the external processing resource to cause the display to display information for guiding or prompting a user of the manipulated mobile electronic device to perform one or more actions in relation to the manipulated mobile electronic devices, for example wherein the one or more actions to be performed in relation to the manipulated mobile electronic device comprise activating or operating an input element of the manipulated mobile electronic device.

30. The method as claimed in claim 1, wherein the mobile electronic device comprises a mobile phone, a smartphone, a smart watch, a component of smart jewelry, a portable digital assistant (PDA), a digital camera, an intelligent device for the “Internet of Things” (or “IOT”), a drone device, a mobile subscriber communication device, a tablet computer, a media player, a smart vehicle, a smart TVs, a laptop computer, and an electronic device equipped with an accelerometer.

31. The method as claimed in claim 1, wherein a color marker is associated with each of the plurality of connected devices, and each respective graphical representations respectively corresponding to the plurality of connected devices appears in a color associated with the respective color marker.

32. The method as claimed in claim 1, wherein shaking the manipulated mobile device results in a corresponding visual representation on the display of the processing station changing color for the visual representation.

33. The method as claimed in claim 5, wherein the diagnostic and/or provisioning procedure is performed in part on the processing station and in part on the manipulated mobile device.

34. A system for use in determining a status of a mobile electronic device, the system comprising the processing station including an external processing resource which is external to the plurality of connected mobile device, wherein the external processing resource is configured for communication with each of the connected mobile devices and is configured to perform the method of claim 1.

35. A computer program stored in the memory of the processing station for use in determining a status of a mobile electronic device, the computer program being configured so that, when executed by an external processing resource external to the plurality of connected mobile device, the external processing resource performs the method of claim 1.
